(19) United States
(12) Patent Application Publication
(10) Pub. No.: US 2010/0077615 A1
(43) Pub. Date: Apr. 1, 2010

(54) METHOD FOR MANUFACTURING A PLATE-TYPE HEAT PIPE

(75) Inventor: CHUEN-SHU HOU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXCONN TECHNOLOGY CO., LTD., Tu-Cheng (TW)

(21) Appl. No.: 12/238,447

(22) Filed: Sep. 26, 2008

(51) Int. Cl. B23P 15/26

(52) U.S. Cl. 29/890.039

(57) ABSTRACT

A method for manufacturing a plate-type heat pipe includes the steps of: offering a top plate, a base plate, a wick structure adhered to the base plate; securing the top plate onto the base plate to make the top plate contact with the base plate; offering a microwave oven which includes a cover and a heating member located at a center portion of the cover, the cover defining an opening at a side thereof to allow microwave to enter the cover, the heating member defining a chamber; putting the secured top and base plates into the chamber of the heating member and turning on the microwave oven to make the microwave produced by the microwave oven enter the cover, the heating member absorbing the microwave and transforming the microwave to heat energy to heat the plate-type heat pipe, whereby the base and top plates are heated and hermetically assembled together.

### BACKGROUND OF THE INVENTION

1. Field of the Invention

The present invention relates to a method for manufacturing a plate-type heat pipe, and more particularly to a method for manufacturing a plate-type heat pipe having a good hermeticity.

2. Description of Related Art

Generally, plate-type heat pipes efficiently dissipate heat from heat-generating components such as a central processing unit (CPU) of a computer. A conventional plate-type heat pipe comprises a top plate, a base plate engaging with the top plate, and a wick structure formed on the base plate. The top plate and the base plate are assembled together by welding. When heat generated by a heat-generating component is inputted into the plate-type heat pipe via its heat absorbing portion, working fluid contained in the wick structure on the heat absorbing portion absorbs the heat and turns into vapor. The vapor presses joins of the top plate and the base plate and may leak out of the plate-type heat pipe from the joins between the top and base plates. On the other hand, the welding connection of the top plate and the base plate requires a quite long period to be cooled. Thus, the production cycle of the plate-type heat pipe is long, whereby the fabrication cost of the plate-type heat pipe is high.

It is therefore desirable to provide a method for manufacturing a plate-type heat pipe having a good hermeticity and a low cost.

### SUMMARY OF THE INVENTION

A method for manufacturing a plate-type heat pipe includes the steps of: offering a top plate, a base plate, a wick structure adhered to the base plate; securing the top plate onto the base plate to make the top plate contact with the base plate; offering a microwave oven which includes a cover and a heating member located at a center portion of the cover, the cover defining an opening at a side thereof to allow microwave to enter the cover, the heating member defining a chamber; putting the secured top and base plates into the chamber of the heating member and turning on the microwave oven to make the microwave produced by the microwave oven enter the cover, the heating member absorbing the microwave and transforming the microwave to heat energy to heat the plate-type heat pipe whereby the base and top plates are heated and hermetically assembled together.

Other advantages and novel features will become more apparent from the following detailed description of preferred embodiments when taken in conjunction with the accompanying drawings.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an exploded, cross-sectional view of a plate-type heat pipe in accordance with a first embodiment of the present invention.

FIG. 2 is a cross-sectional view showing the plate-type heat pipe of FIG. 1 located in a microwave oven.

FIG. 3 is a cross-sectional view showing a plate-type heat pipe in accordance with a second embodiment of the present invention located in the microwave oven.

FIG. 4 is a cross-sectional view showing a plate-type heat pipe in accordance with a third embodiment of the present invention located in the microwave oven.

FIG. 5 is a cross-sectional view showing a plate-type heat pipe in accordance with a fourth embodiment of the present invention located in the microwave oven.

### DETAILED DESCRIPTION OF THE INVENTION

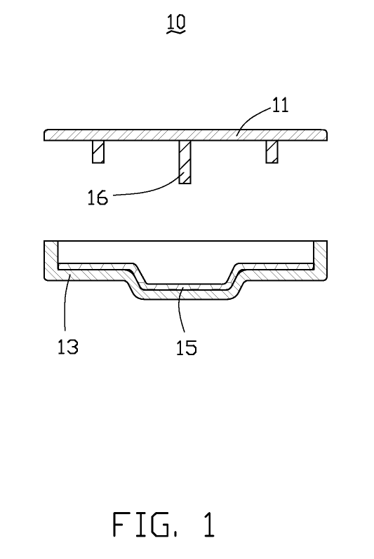

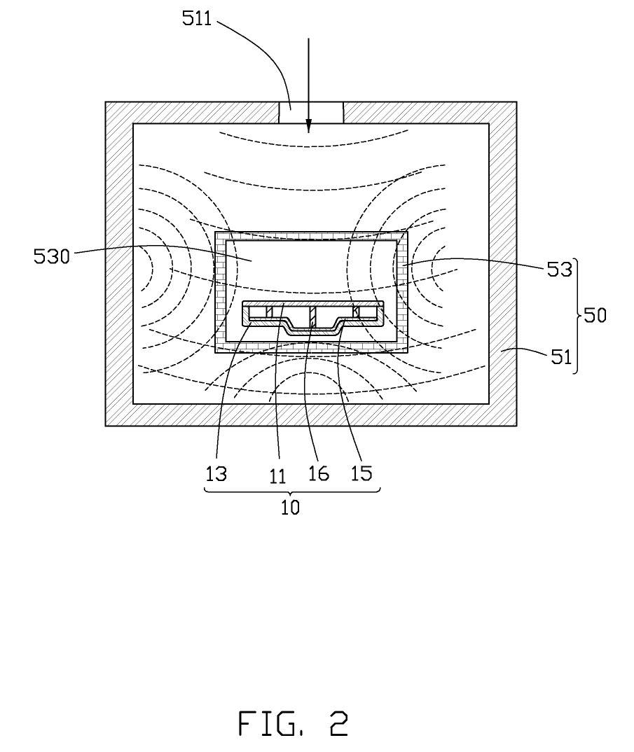

Referring to FIGS. 1-2, a method for manufacturing a plate-type heat pipe 10 in accordance with a first embodiment of the present invention comprises the steps of: 1) offering an elongated top plate 11, a bended base plate 13 engaging with the top plate 11, a wick structure 15 securely adhered to a top surface of the base plate 13, and a plurality of supporting poles 16 mounted on a bottom surface of the top plate 11; 2) securing the top plate 11 onto the base plate 13, in this state, the bottom surface of the top plate 11 contacting with a top surface of a periphery of the base plate 13, the supporting poles 16 abutting against a top surface of the wick structure 15; 3) offering a microwave oven 50, the microwave oven 50 comprising a cubical metal cover 51 and a cubical heating member 53 located at a center portion of the cover 51, the cover 51 defining an opening 511 at a side thereof to allow microwave to enter the cover 51, the heating member 53 defining a chamber 530 to receive the plate-type heat pipe 50 therein; 3) putting the secured top and base plates 11, 13 into the chamber 530 of the heating member 53 of the microwave oven 50 and turning on the microwave oven 50 to make the microwave produced by the microwave oven 50 enter the cover 51, the heating member 53 absorbing the microwave and transforming the microwave into heat energy to heat the plate-type heat pipe 10, in this state, the top and base plates 11, 13 being hermetically assembled together and the supporting poles 16 being securely mounted on the top surface of the wick structure 16.

In this embodiment, the heating member 53 of the microwave oven 50 is made of graphite, silicon carbide or high dielectric constant ceramic composites. The heating member 53 absorbs microwave produced by the microwave oven 50 and transforms the microwave into heat energy quickly to heat the plate-type heat pipe 10. Joints of the top and base plates 11, 13 are located at opposite ends of the plate-type heat pipe 10. The joints are near to the sidewalls of the heat member 53, so the heat energy of the heating member 53 transfers to the joints quickly. When a temperature of the joints of the top and base plates 11, 13 is high, the top and base plates 11, 13 are firmly bonded together. When the heat of the opposite ends of the plate-type heat pipe 10 and the heating member 53 of the microwave oven 50 is transfers to the other portion of the plate-type heat pipe 10, the supporting poles 16 and the wick structure 15 are assembled together. Because heat of the plate-type heat pipe 10 is mostly accumulated on the opposite ends thereof; thus, the heat can be dissipated from the plate-type heat pipe 10 rapidly after the top and base plates 11, 13 are hermetically connected together. Thus, the production cycle of the plate-type heat pipe is short and the fabrication cost of the plate-type heat pipe is thereby lower than the conventional plate-type heat pipe.

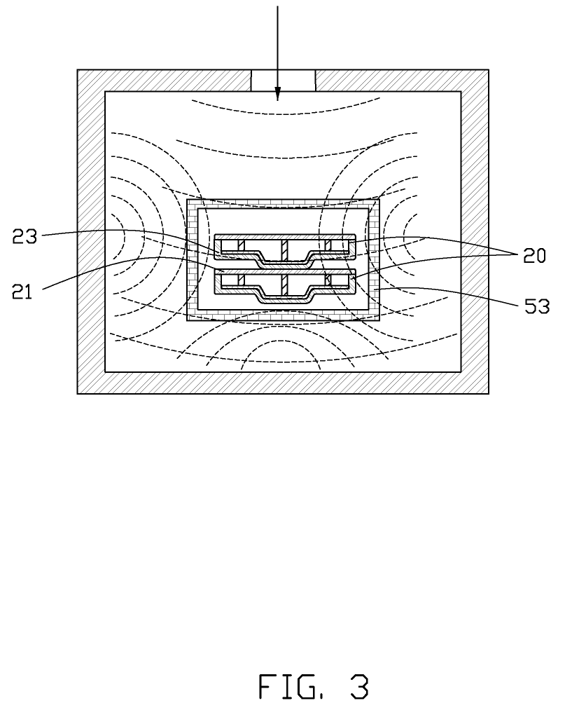

Referring to FIG. 3, a method for manufacturing a plate-type heat pipe 20 in accordance with a second embodiment of the present invention is similar to the method of the first embodiment of the present invention, except that two plate-type heat pipes 20 are received in the heating member 53. The plate-type heat pipes 20 are aligned. A base plate 23 of one plate-type heat pipe 20 abuts against a top plate 21 of another plate-type heat pipe 20. The plate-type heat pipe 20 is identical to the plate-type heat pipe 10.

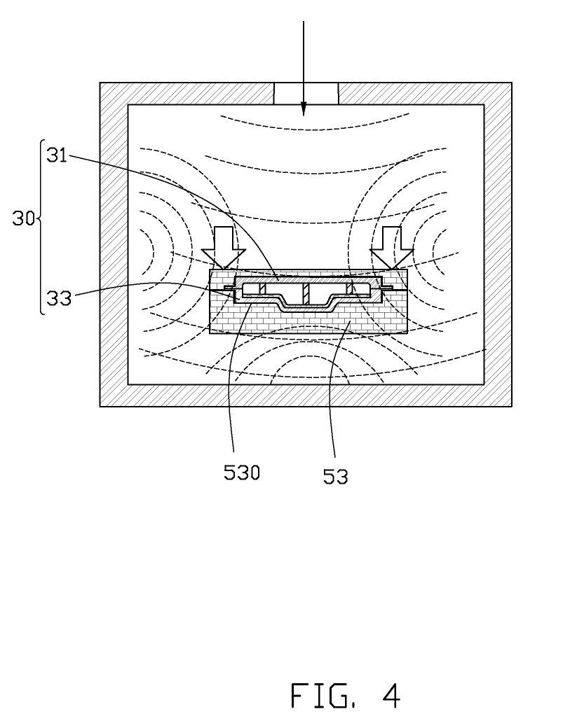

Referring to FIG. 4, a method for manufacturing a plate-type heat pipe 30 in accordance with a third embodiment of the present invention is similar to the method of the first embodiment of the present invention, except that a contour of the chamber 530 of the heating member 53 of the microwave oven 50 is compliant to and the same as that of the plate-type heat pipe 30, and the heating member 53 is divided into an upper half (not labeled) and a lower half (not labeled). A downwardly pressing force is applied on the upper half toward the lower half whereby a periphery of the top plate 31 and a periphery of the base plate 33 are compressed between the upper half and the lower half of the heating member 53, meanwhile the heating member 53 transforms the microwave into heat energy heating the top and base plates 31, 33; thus, the top and base plates 31, 33 of the plate-type heat pipe 30 are hermetically assembled together quickly.

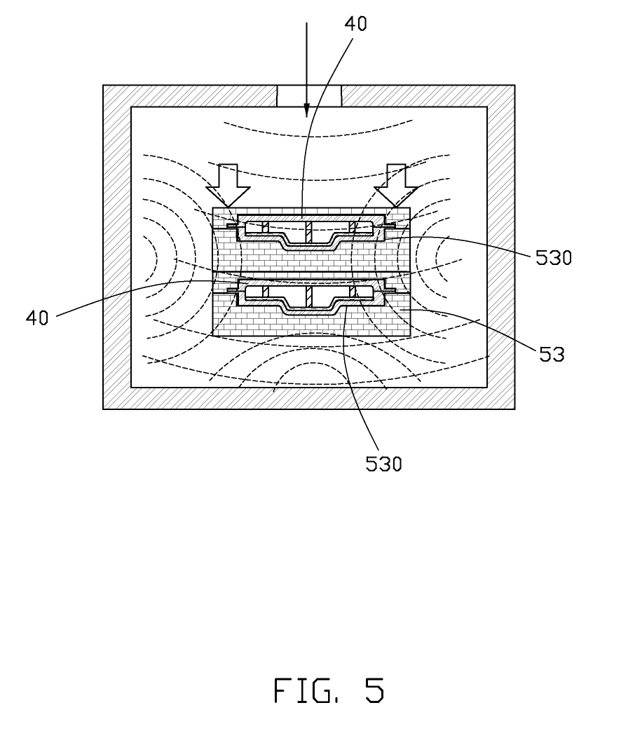

Referring to FIG. 5, a method for manufacturing a plate-type heat pipe 40 in accordance with a fourth embodiment of the present invention is similar to the method of the third embodiment of the present invention, except that the heating member 53 defines two chambers 530 to receive two plate-type heat pipes 40 therein.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A method for manufacturing a plate-type heat pipe comprising the steps of:
offering a top plate, a base plate engaging with the top plate, and a wick structure securely adhered to a top surface of the base plate;
putting the top plate and the base plate with the wick structure into a microwave oven, the microwave oven comprising a cover and a heating member located inside the cover, the top plate and the base plate with the wick structure being received in a chamber defined by the heating member;
turning on the microwave oven to make the microwave oven produce microwave entering the cover, the heating member absorbing the microwave and transforming the microwave to heat energy to heat the base plate and top plate whereby the base plate and top plate are hermetically assembled together.

2. The method for manufacturing a plate-type heat pipe as claimed in claim 1, wherein joints of the top and base plates are located near the heating member of the microwave oven.

3. The method for manufacturing a plate-type heat pipe as claimed in claim 1, wherein a contour of the chamber of the heating member of the microwave oven is compliant to and the same as that cooperatively formed by outlines of the top plate and the base plate, a periphery of the top plate and a periphery of the bottom plate being compressed between upper and lower halves of the heating member.

4. The method for manufacturing a plate-type heat pipe as claimed in claim 1, wherein the heating member of the microwave oven is made of one graphite, silicon carbide and high dielectric constant ceramic composites.

5. The method for manufacturing a plate-type heat pipe as claimed in claim 1, wherein a plurality of supporting poles extends downwardly from the top plate to abut against the wick structure of the base plate.

6. The method for manufacturing a plate-type heat pipe as claimed in claim 1, wherein an opening is defined through the cover, the microwave entering the cover through the opening.

7. The method for manufacturing a plate-type heat pipe as claimed in claim 1, wherein the heating member is located at a center of the cover.
